(19) United States
(12) Patent Application Publication
(10) Pub. No.: US 2026/0148346 A1
(43) Pub. Date: May 28, 2026

(54) PERSONALIZED SELFIE AESTHETIC ENHANCEMENT

(71) Applicant: Snap Inc., Santa Monica, CA (US)

(72) Inventors: Jian Wang, West New York, NJ (US); Sizhuo Ma, Long Island City, WI (US); Pradyumna Chari, Los Angeles, CA (US); Kfir Aberman, Redwood City, CA (US); Daniil Ostashev, London (GB); Konstantin Gudkov, Playa Vista, CA (US); Gurunandan Krishnan Gorumkonda, Kirkland, WA (US)

(21) Appl. No.: 18/960,128

(22) Filed: Nov. 26, 2024

(51) Int. Cl. G06T 5/60

(52) U.S. Cl. CPC G06T 5/60; G06T 2200/24; G06T 2207/20081; G06T 2207/20084; G06T 2207/30201

(57) ABSTRACT

Methods, systems, mobile devices, and non-transitory computer-readable mediums for easily aesthetically enhancing images such as selfies. An example algorithm's input has three parts: image, manipulation magnitude, and text guidance. The algorithm includes two parts: (1) guidance generation based on public and personal aesthetic preferences, and (2) selfie generation. The first part outputs an image to maximize an aesthetic enhancement score (e.g., a beauty score) while following the manipulation input where the output image contains a manipulation direction. The second part is a conditional diffusion model that accepts the rendered output image from the first part and is conditioned on the input image and outputs the final image. The second part is personalized by the user's images.

### TECHNICAL FIELD

The subject matter herein relates to image processing to improve appearance, e.g., aesthetically enhancing selfies (e.g., to improve appearance).

### BACKGROUND

Electronic devices, such as smartphones, available today integrate cameras and processors configured to capture images and manipulate the captured images.

A selfie is a self-portrait photograph, typically taken with a camera of a portable electronic device such as a smartphone, which is usually held in the hand. Selfies are typically taken with the camera held at arm's length, as opposed to those taken by a selfie stick, using a self-timer or remote. Due to the limited distance imposed by the user's arm's length, such self-portrait photographs often appear distorted.

### BRIEF DESCRIPTION OF THE DRAWINGS

In the drawings, which are not necessarily drawn to scale, like numerals may describe similar components in different views. Some nonlimiting examples are illustrated in the figures of the accompanying drawings in which:

FIG. 1A is an illustration depicting a graphical user interface (GUI) for a personalized aesthetically enhanced model implemented on a mobile device;

FIGS. 1B-1F are illustrations depicting output images generated by a personalized aesthetically enhanced model responsive to different manipulation guidance;

FIG. 2A-2E are illustrations depicting different output images generated by a personalized aesthetically enhanced model responsive to the same manipulation guidance;

FIG. 3 is a block diagram of a personalized aesthetically enhanced model pipeline;

FIGS. 4A-4C are block diagrams depicting a manipulation guidance generation neural network for use in the personalized aesthetically enhanced model pipeline of FIG. 3 and training thereof;

FIG. 4D is a graph depicting manifolds of aesthetically grouped facial images for use in understanding the principles of operation;

FIGS. 5A and 5B are block diagrams depicting a selfie generation neural network for use in the personalized aesthetically enhanced model pipeline of FIG. 3;

FIG. 5C is a block diagram depicting a selfie generation neural network for use in the personalized aesthetically enhanced model pipeline of FIG. 3 with a manipulation guidance value set to zero and no textual guidance.

FIGS. 6A-6E are block diagrams depicting training of the selfie generation neural network of FIGS. 5A and 5B;

FIGS. 7A-7C are block diagrams depicting alternative arrangements for adding image encoder output to the diffusion model in the selfie generation neural network;

FIG. 8 is a block diagram depicting an example mobile device for implementing a personalized aesthetically enhanced model.

FIG. 9 is a block diagram of a machine adapted to perform one or more of the methodologies described herein.

FIG. 10 is a block diagram showing a software architecture within which examples described herein may be implemented.

### DETAILED DESCRIPTION

Various implementations and details are described with reference to examples for improving the appearance of selfies. The appearance of a selfie is improved through the use of a personalized aesthetically enhanced model including a first neural network (e.g., a manipulation guidance generation neural network) and a second neural network (e.g., a selfie generation neural network). The first neural network is trained using publicly available face attractiveness information and personalized preferences and the second neural network is trained using a limited set of pre-selected images of the subject of the selfie (e.g., 5-20 images of the user of the mobile device).

When a user takes a selfie, the selfie may not look the best, e.g., the image may be blurry or noisy (real-world images often have some degradation), the lighting is not optimal, the expression/gaze may not be good (eyes closed), the face is typically distorted due to short camera-to-face distance, the face may be blurry due to hand shaking, the image may be noisy due to bad lighting, the expression or gaze may not be good due to casual/amateur capturing, the user's makeup may be unprofessional, and the pose may not be flattering.

A user may want to adjust the selfie to produce a cleaner or more flattering image. One option available to the user is to manipulate images manually. Alternatively, a computer program could be used to predict the best and closest lighting, expression and pose for the current input of the user. Such changes (e.g., sharpness, resolution, lighting, head tilt/pose, and gaze) cannot be done by editing the original, but rather by generating an entirely new image based on the original.

However, the original may not contain all the information needed to produce a cleaner image or to provide options from which the user may select. In one example, photos of the user in their phone may be used to train a neural network (e.g., the second neural network) to produce one or more generative output images from which the user may select. Better results are achieved by training the neural network with images of the user which can be obtained directly from video/photo albums in the user's phone. In particular images of the same person are used to train a personalized aesthetically enhanced model, and then given an input image and the user's preference, the generative model can output a better image (same content as the input but looks better).

Traditional machine learning models, like face image restoration model and face image manipulation model, work for all images, but the results tend to lose subtle but important facial details. This is particularly relevant for facial images as humans are evolutionarily hyper-sensitive to nuances in faces, especially their own.

By creating a personalized model for each person, the appearance of the selfie can be improved for saving and sharing, while also retaining the appearance of other objects in the frame (e.g., the user's pets, possessions, familiar backgrounds, etc.).

Examples of the personalized aesthetically enhanced model described herein can also predict the best and closest lighting, expression and pose for the current input of the user, based on analyzing user face manipulation history, user selfie discard history, or doing a user study (ask the user preference of their face); and based on face aesthetics.

The following detailed description includes systems, methods, techniques, instruction sequences, and computing machine program products illustrative of examples set forth in the disclosure. Numerous details and examples are included for the purpose of providing a thorough understanding of the disclosed subject matter and its relevant teachings. Those skilled in the relevant art, however, may understand how to apply the relevant teachings without such details. Aspects of the disclosed subject matter are not limited to the specific devices, systems, and methods described because the relevant teachings can be applied or practiced in a variety of ways. The terminology and nomenclature used herein is for the purpose of describing particular aspects only and is not intended to be limiting. In general, well-known instruction instances, protocols, structures, and techniques are not necessarily shown in detail.

The terms “coupled” or “connected” as used herein refer to any logical, optical, physical, or electrical connection, including a link or the like by which the electrical or magnetic signals produced or supplied by one system element are imparted to another coupled or connected system element. Unless described otherwise, coupled or connected elements or devices are not necessarily directly connected to one another and may be separated by intermediate components, elements, or communication media, one or more of which may modify, manipulate, or carry the electrical signals. The term “on” means directly supported by an element or indirectly supported by the element through another element that is integrated into or supported by the element.

The term “proximal” is used to describe an item or part of an item that is situated near, adjacent, or next to an object or person; or that is closer relative to other parts of the item, which may be described as “distal.” For example, the end of an item nearest an object may be referred to as the proximal end, whereas the generally opposing end may be referred to as the distal end.

The orientations of the devices, associated components, and any other devices incorporating, for example, a camera, an inertial measurement unit, or both such as shown in any of the drawings, are given by way of example only, for illustration and discussion purposes. In operation, the devices may be oriented in any other direction suitable to the particular application of the device; for example, up, down, sideways, or any other orientation. Also, to the extent used herein, any directional term, such as front, rear, inward, outward, toward, left, right, lateral, longitudinal, up, down, upper, lower, top, bottom, side, horizontal, vertical, and diagonal are used by way of example only, and are not limiting as to the direction or orientation of any camera or inertial measurement unit as constructed or as otherwise described herein.

Reference now is made in detail to the examples illustrated in the accompanying drawings.

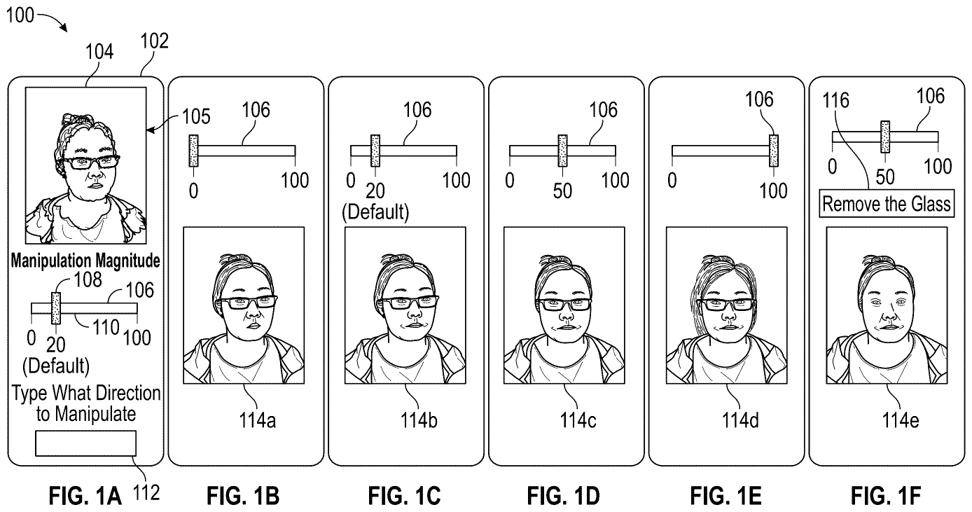

FIG. 1A depicts an example user interface (UI) 100 for a mobile device 102 for implementing personalized aesthetically enhanced models such as described herein. The mobile device 102 includes a display 105 (e.g., a touch-sensitive display) for presenting a user interface 100 that displays images 104 (e.g., a selfie image) and receives manipulation guidance for manipulating the selfie image. Manipulation guidance may include a manipulation magnitude value (e.g., 0 to 100) and a manipulation instruction (e.g., remove glasses, turn head left, smile close mouth, turn head right, etc.).

In the illustrated embodiment, the UI 100 includes a slider 106 for receiving the manipulation magnitude value and a text box 112 for receiving manipulation instructions. The slider 106 includes an indicator 108 on a scaled bar 110 allowing a user to input a manipulation magnitude value by pressing and holding the indicator with a finger and then, moving their finger along the scaled bar and releasing to select the desired manipulation magnitude value. Other apparatus and techniques could be used to provide manipulation guidance. For example, a microphone and speech to text converter may be used to capture manipulation instructions. Although the examples are described herein for use with a mobile telephone type device, one of skill in the art will understand that other mobile devices may be used, e.g., a tablet or personal computer.

In one example, after selecting the desired manipulation guidance, tapping on the image 104 presented on the display 105 of the mobile device 102 after the manipulation guidance is received captures the manipulation guidance and initiates the personalized aesthetically enhanced model. FIG. 1B depicts an output image 114a of a personalized aesthetically enhanced model for an input image 104 with the manipulation guidance value set to zero and no manipulation direction provided. In this instance, the personalized aesthetically enhanced model does image enhancement or restoration (such as denoising and deblurring).

FIG. 1C depicts an output image 114b of a personalized aesthetically enhanced model for an input image 104 with the manipulation guidance value set to 20 and no manipulation direction provided. In this instance, the personalized aesthetically enhanced model makes small changes like expression, eye shape, face shape, and skin change.

FIG. 1D depicts an output image 114c of a personalized aesthetically enhanced model for an input image 104 with the manipulation guidance value set to 50 and no manipulation direction provided. In this instance, the personalized aesthetically enhanced model additionally does medium changes like pose changes.

FIG. 1E depicts an output image 114d of a personalized aesthetically enhanced model for an input image 104 with the manipulation guidance value set to 100 and no manipulation direction provided. In this instance, the personalized aesthetically enhanced model additionally does large changes like camera-to-face distance change.

FIG. 1F depicts an output image 114e of a personalized aesthetically enhanced model for an input image 104 with the manipulation guidance value set to 50 and a manipulation direction equal to “Remove the glass” 116. In this instance, the personalized aesthetically enhanced model additionally does what the text says (i.e., removes the glass, e.g., eyeglasses).

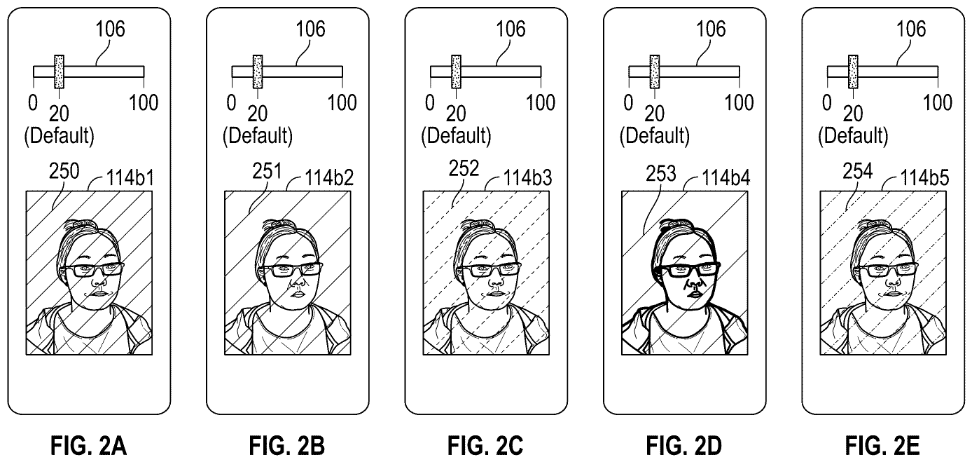

As depicted in FIGS. 2A-2E, the personalized aesthetically enhanced model, may generate multiple outputs for each setting. In accordance with this example, the user may select the desired output image by using a swiping gesture on the display 105 of the mobile device 102. For example, the personalized aesthetically enhanced model may additionally display output image 114b1 shown in FIG. 2A. Swiping left on the display may then display output image 114b2 shown in FIG. 2B. The user may then swipe left a subsequent time to display output image 114b3 shown in FIG. 2C (and again for output image 114b4 shown in FIG. 2D and again for output image 114b5 shown in FIG. 2E). The user may also swipe right to return to a previously displayed output image (such as image 114b1 shown in FIG. 2A). Each of the output images may have different characteristics (e.g., brightness, sharpness, coloring, etc.). For example, output image 114b1 may have a brightness level (represented by the spacing of diagonal lines 250) that is similar to the brightness level of output images 114b3 and 114b5 (represented by the spacing of diagonal lines 252 and 254). Output image 114b2, on the other hand may be brighter (represented by the increased spacing of diagonal lines 251) and output image 114b4 may be even brighter (represented by the increased spacing of diagonal lines 253). In other examples, output image 114b3 may have different coloring (represented by the diagonal lines 252 having a dash pattern) and output image 114b5 may have a different saturation level (represented by the diagonal lines 254 having a dash-dot-dash pattern). Other distinct characteristics and combinations for each of the output images will be understood by one of skill in the art from the description herein.

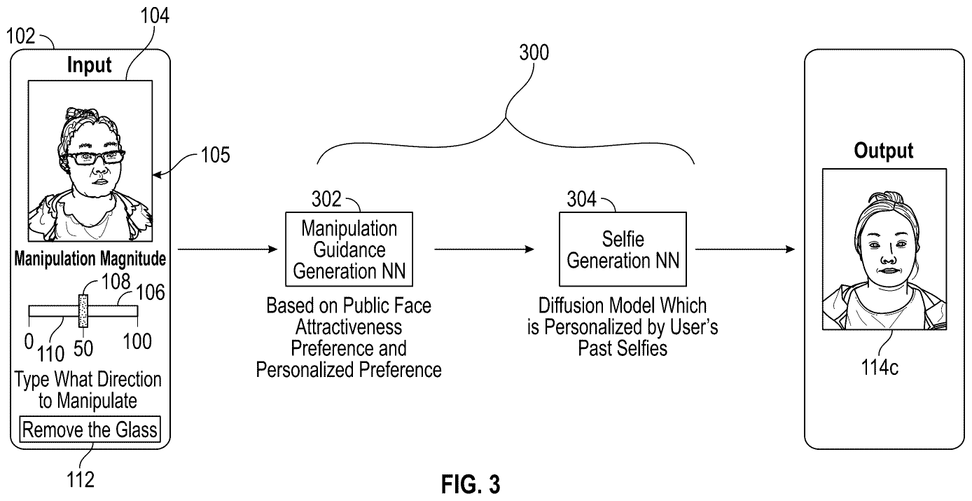

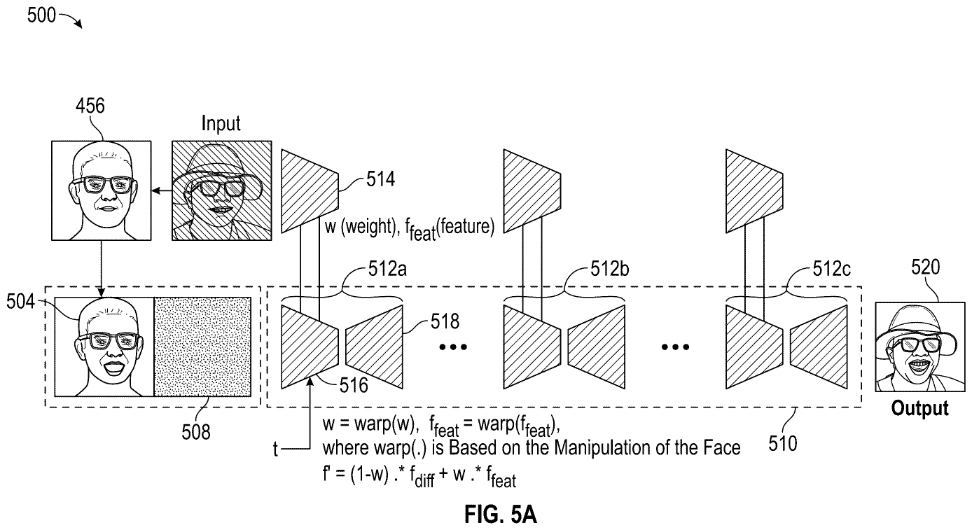

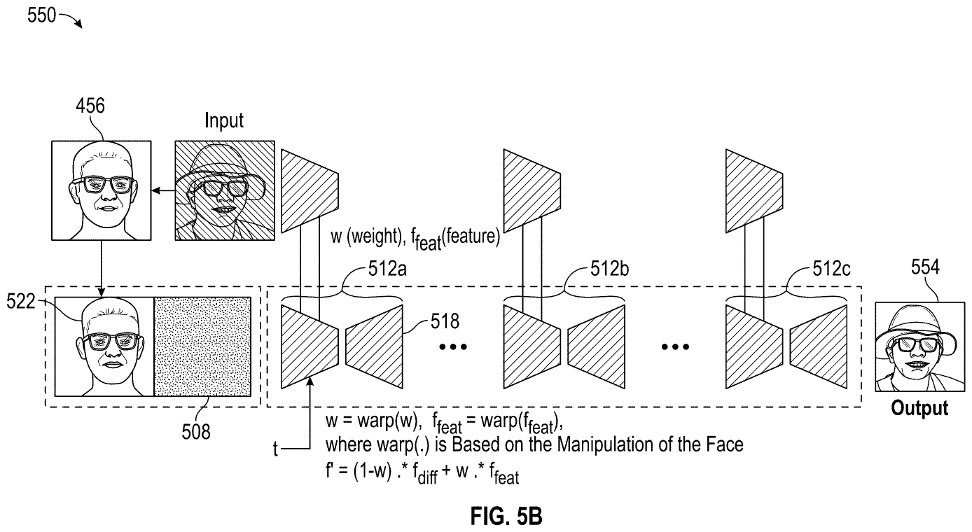

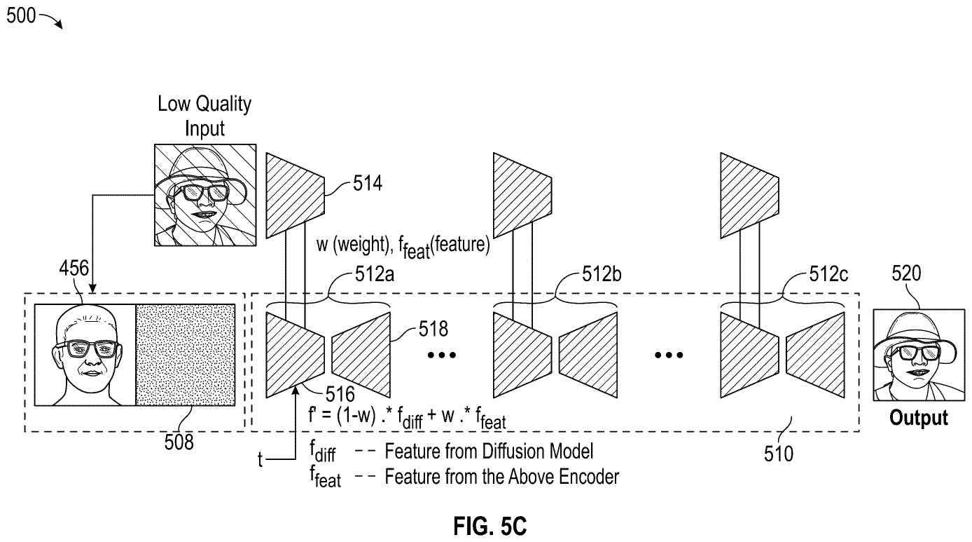

FIG. 3 depicts an example personalized aesthetically enhanced model pipeline 300. The pipeline 300 includes a manipulation guidance generation neural network 302 and a selfie generation neural network 304. Input image 104 from the user interface 100 presented on the display 105 of the mobile device 102 is passed through the manipulation guidance generation neural network 302 and then processed through the selfie generation neural network 304 responsive to the manipulation guidance. For example, when the manipulation magnitude value is set to 50 and the manipulation instruction is “remove the glass,” the personalized aesthetically enhanced model pipeline 300 will produce an output image (e.g., output image 114c). In one example, when the manipulation magnitude value=0 and no text guidance), the personalized aesthetically enhanced model provides image restoration/enhancement using the selfie generation neural network 304 and the manipulation guidance generation neural network 302 is effectively omitted. This is depicted in FIG. 5C.

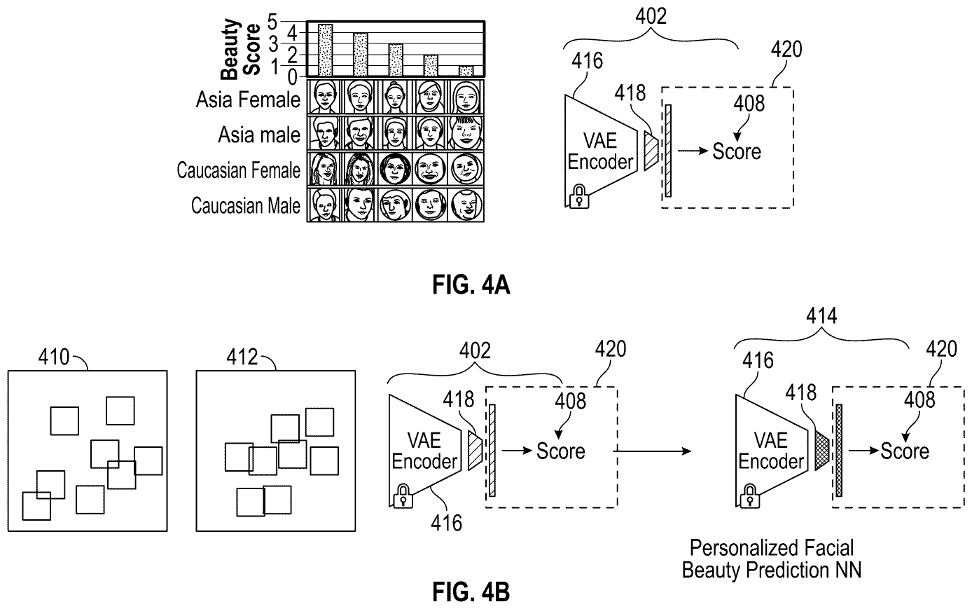

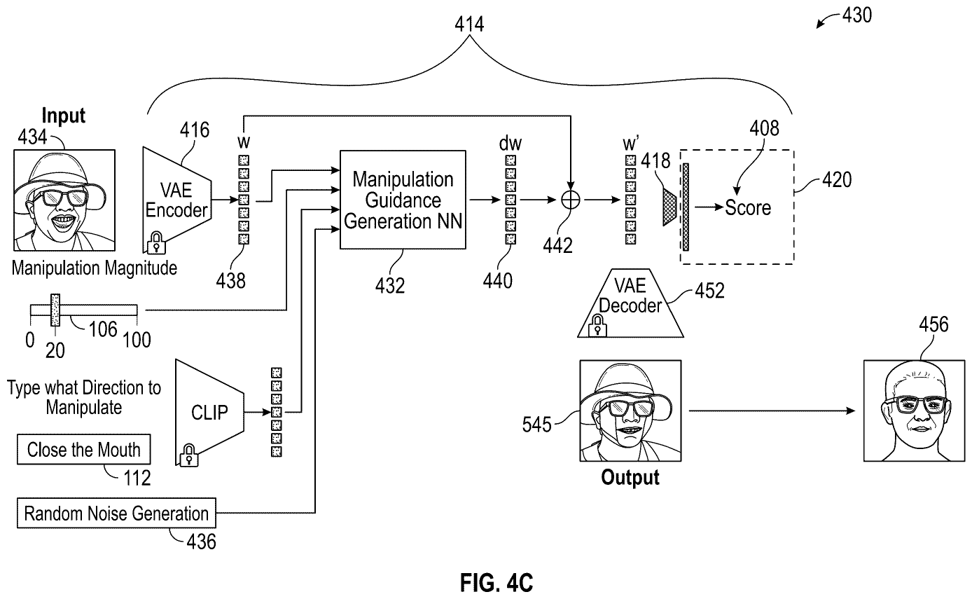

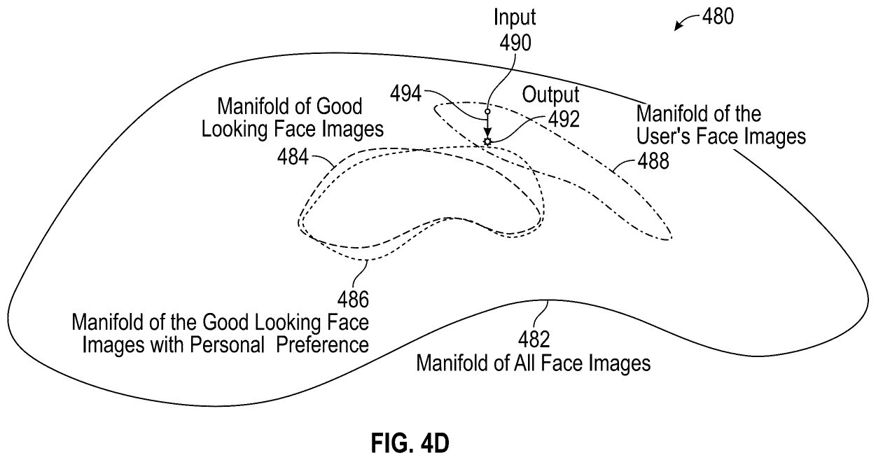

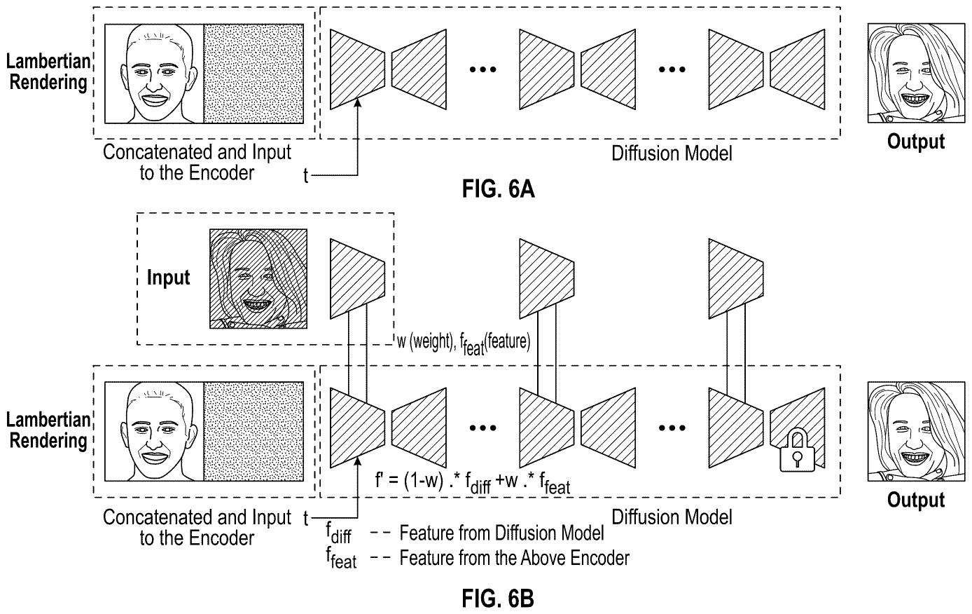

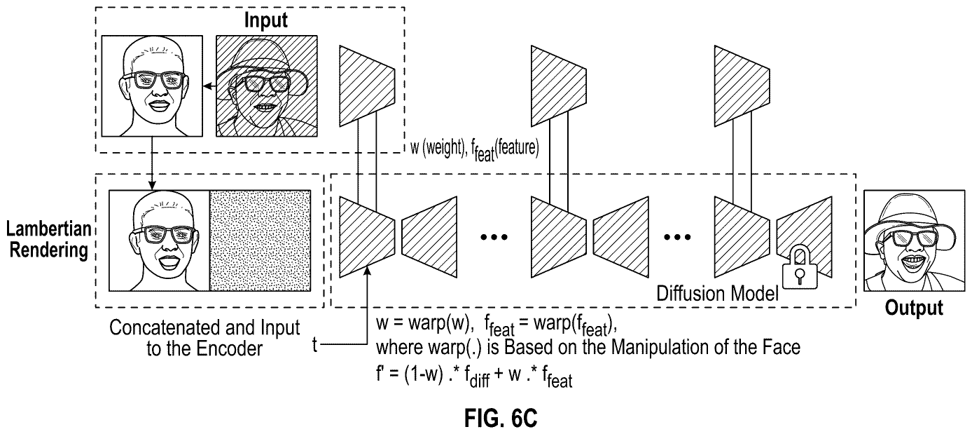

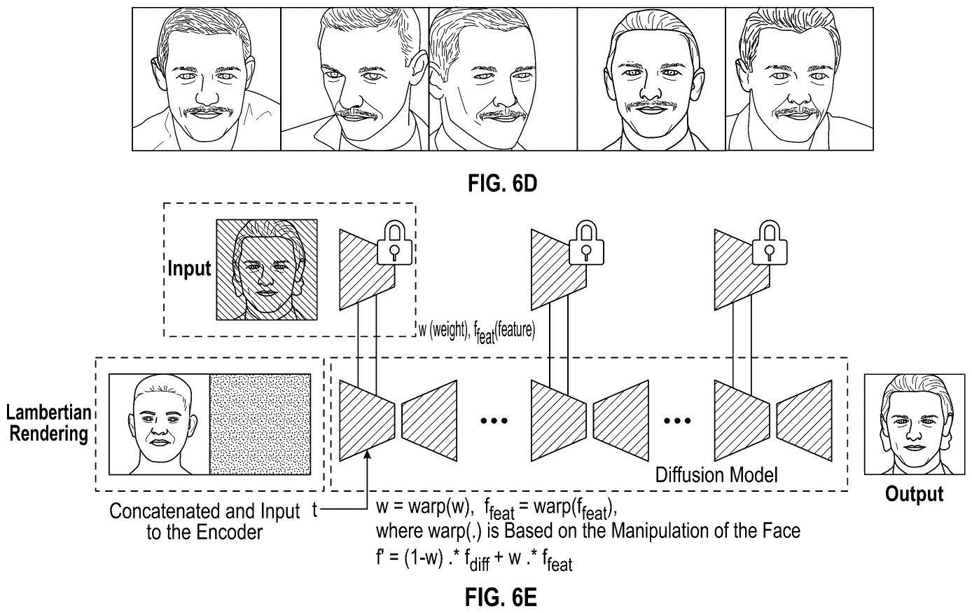

The manipulation guidance generation neural network 302 is trained using publicly available face attractiveness preferences. The selfie generation neural network 304 is trained using a limited set of pre-selected images of the subject of the selfie (e.g., 5-20 images of the user of the mobile device). Additional details regarding the training of the manipulation guidance generation neural network 302 are set forth below with reference to FIGS. 4A-4C and the selfie generation neural network 304 are set forth below with reference to FIGS. 6A-6E.

As shown in FIG. 4A, to train the manipulation guidance generation neural network 302, a general facial beauty neural network 402 is first trained using a public dataset of facial images that are scored based on the attractiveness (such as SCUT-FBP5500: A Diverse Benchmark Dataset for Multi-Paradigm Facial Beauty Prediction, Liang et al, 2018). The illustrated general facial beauty neural network 402 may be a VAE encoder 416 and one or more convolution layers 418 (also referred to as a convolutional net head) and a Bayesian ridge regressor 420 that process the public dataset of image to obtain a score 408.

The general facial beauty neural network 402 is then refined/fine tuned as shown in FIG. 4B using personal data of the user to train a personalized facial beauty prediction neural network 414. The personal data for the user may include, for example, “liked” photos 410 saved by the user or photos saved on the user's mobile device 102 (as opposed to unliked or discarded photos 412), user face manipulation history, user selfie discard history, or doing a user study (ask the user preference of their face). In one example, the personal data photos may contain background details (e.g., pets, automobile, etc.) that has been found to be useful in more accurately reproducing image data surrounding the user's face. The illustrated personalized facial beauty neural network 414 may include a VAE encoder 416 having one or more convolution layers 418 and a Bayesian ridge regressor 420 that refines/fine tunes the score 408.

FIG. 4C depicts a manipulation guidance generation neural network 432 and how to train it for use as the manipulation guidance generation neural network 302 for use in the personalized aesthetically enhanced model. For this neural network 302, there are four inputs: an input image 434, a manipulation magnitude value (e.g., provided via the slider 106 in this example), manipulation instruction(s) (e.g., provided via text box 112 in this example), and random noise from a random noise generator 436 (to add randomness to the output, e.g., for use in producing multiple output images 114 like those in FIGS. 2A-2E).

The overall framework 430 of the design of the manipulation guidance generation neural network 432 is now described. The framework 430 includes a VAE image encoder 416 that generates latent code (w) 438, a contrastive language-image pre-training (CLIP) encoder that generates text embedding, and a VAE decoder 452. The manipulation guidance generation neural network 432 sets the manipulation direction (dw; manipulation directed in latent space) 440, which is combined by an adder 442 with the old latent code (w) 438 to generate a new latent code (w′=w+dw). A Bayesian ridge regressor 420 generates a score 408. The VAE decoder produces an output image 545.

The loss design in accordance with one example is as follows in Equation 1:

$$Loss = {λ}_{1} ( 1 / score ) + {{λ}_{2} ( {\vert dw \vert}_{2} - s \cdot mag )}^{2} + {λ}_{3} \vert {E}_{CLIP , T} ( text ) - {E}_{CLIP , I} ( Output ) \vert \qquad Eq . ( 1 )$$

where score is the personalized predicted beautification score, mag is the input manipulation magnitude, and s is a fixed scale parameter which is a hyper-parameter, dw is the manipulation direction in the latent space, ECLIP.T and ECLIP.I are the text and image encoders of CLIP, respectively, Output image 545 is the output image in this stage, but not the final output 456, because it may have artifacts and identity loss, and λ₁, λ₂, and λ₃ are hyperparameters.

The output image 545 in this step can be calculated to get a Lambertian rendering 456, which is the input to the diffusion model in FIG. 5A. In other words, the Lambertian rendering 456 controls the generation process in the selfie generation neural network 304.

FIG. 4D is a graph 480 depicting manifolds of face images and the locations of input and output. Note that the manifold of each grouping resembles a mountain, with contour lines. The scores are highest in the center and gradually decrease as you move outward. Only after setting a threshold will a contour appear.

Assume all the face images lie on a manifold (i.e., the manifold of all face 482). All the good looking/attractive face images lie on a smaller manifold (i.e., the manifold of good looking face images 484). Different people have different preference, which means the manifold of good looking face images with personal preference will be different (i.e., the manifold of the good looking face images with personal preference 486). For the user, all his/her face images lie on another manifold (i.e., the manifold of the user's face images 488).

Given an input image 490, the goal is to manipulate it to generate an output image 492 in a direction 494 that approaches the manifold of the good looking face images with personal preference 486. The larger the “manipulation magnitude” is, the more processing that can occur. Input text guidance provides another constraint that allows or disallows some directions. Note that the above is a simplified explanation of the process to facilitate understanding. In reality, face attractiveness is not either 0 or 1. It's a continuous score. For example, face attractiveness can be indicated by a number from 0 to 5, where 5 means very attractive, and 0 means not attractive at all.

FIGS. 5A and 5B depict details of a selfie generation neural network 500/550 that is being trained to generate the selfie generation neural network 304. The illustrated selfie generation neural network 500 includes a diffusion model 510 for processing a Lambertian rendering 504 concatenated with random noise 508. The diffusion model 510 includes a series of U-nets (represented by three U-nets 512a-c). The Lambertian rendering 504 is generated by first estimating surface normals, lighting, and an albedo map from the input image, and then render a face 456. As described below, if the selfie input image is not being manipulated, the Lambertian rendering 456 may be concatenated with random noise 508 for processing (see FIG. 5C). On the other hand, if the selfie input image is being manipulated (open mouth, turn head, etc.), the Lambertian rendering 456 is first warped to produce Lambertian rendering 504 (scc FIGS. 5A and 5B).

Each U-net 512 has an image encoder 516 and a decoder 518, and is controlled by an external image encoder 514. The input image is input to the image encoder 514, which outputs weight map and feature map at each layer. These two maps are then fused into the diffusion model's encoder 516. More specifically, the input's encoder outputs w (weight), f_{feat} (feature), are added into the diffusion model's encoder's layers according to Equation 2:

$$f ‘ = ( 1 - w ) \cdot * {f}_{diff} + w \cdot * {f}_{feat} , \qquad Eq . ( 2 )$$

where f_{diff} is a feature from the diffusion model 510 and f_{feat} is a feature from the input image's encoder 514.

If there is face manipulation (e.g., the face shape or expression is changed), the features are warped so that they are more spatially aligned. For example, Lambertian rendering 456 is manipulated to Lambertian rendering 504. In the example depicted in FIG. 5A, using neural network 500, the mouth of the input image is not opened widely originally. In order to open the mouth such as depicted in output image 520, a Lambertian rendering 504 is input whose mouth is opened widely. The image feature (e.g., output of the encoder of the input image) and the diffusion feature (features from the Unet in the diffusion model) are not spatially aligned. In the example depicted in FIG. 5B, using neural network 550, the face direction is changed. In order to change the face direction such as depicted in output image 554, a Lambertian rendering 522 is input whose face direction is changed to frontal parallel. The image feature (e.g., output of the encoder of the input image) and the diffusion feature (features from the Unet in the diffusion model) are not spatially aligned. To correct for the misalignment in these two examples, the weight map and feature map (f_{feat}) are warped according to Equation 3 and then added according to Equation 4:

$$w = warp ( w ) , {f}_{feat} = warp ( {f}_{feat} ) , \qquad Eq . ( 3 )$$

$$f ‘ = ( 1 - w ) \cdot * {f}_{diff} + w \cdot * {f}_{feat} \qquad Eq . ( 4 )$$

where warp(.) is based on the manipulation of the face; in the case of FIG. 5A, warp(.) is to warp the mouth region to be wide open; and, in the case of FIG. 5B, warp(.) is to change the face direction to be frontal parallel.

FIGS. 6A-6E depict details of the training of the selfie generation neural network 500 to make it personalized for use as selfie generation neural network 304.

FIG. 6A depicts training using a Lambertian rendering as an input to an unconditional, generalized face diffusion model. Training may be performed using a high-quality image dataset of human faces such as Flickr-Faces-HQ (FFHQ; which includes ˜70,000 high quality face images). For each image in the dataset, a Lambertian rendering is calculated.

FIG. 6B depicts training a generalized, conditional diffusion model focused on face restoration. To train the image encoder of the diffusion model, the weights of the diffusion model are frozen. Parallel feature extractors for the input image (i.e., the encoder for the input image) are then trained, with inputs being synthetically augmented with random degradations with the target being the original, undegraded image.

FIG. 6C depicts finetuning the image encoder using images of different viewpoints or expressions, e.g., face video data. The training data set may be a large-scale video facial attributes dataset such as CelebV-HQ (CelebV-HQ: A Large-scale Video Facial Attributes Dataset, ECCV 2022).

FIG. 6D depicts a small, personalized photo album (5-20 images) of the user, e.g., obtained from the user's mobile device. The images may be collected from an existing photo album on the mobile device 102. The images may be automatically or manually realigned and cropped to obtain a centered face. Optionally the selected images from the photo album can be conditioned on image quality measurement (by choosing high quality images).

FIG. 6E depicts personalizing the conditional diffusion model using the small, personalized photo album from FIG. 6D. The weights of the feature extractors (image encoder of the input image) are frozen. The diffusion model is then trained on the small, personalized album, with the input images to the feature extractor degraded with the target being the original, undegraded image.

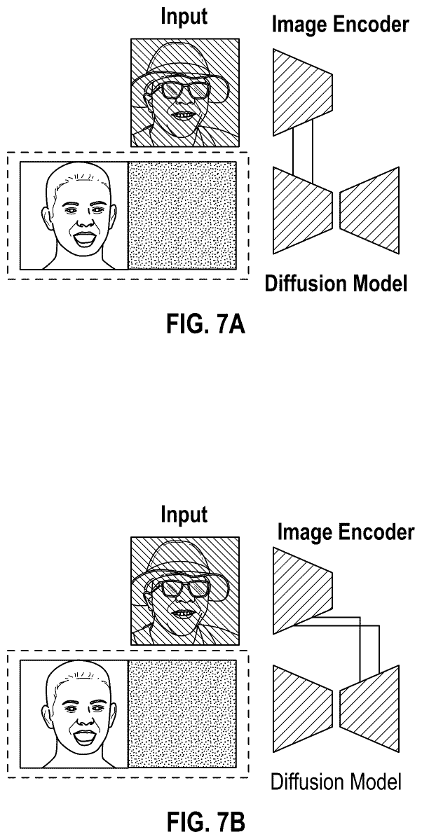

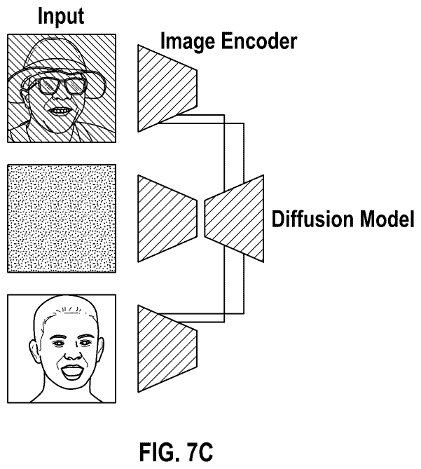

FIGS. 7A-7C depict alternative design for coupling the image encoder's output to the diffusion model's Unet in the selfie generation neural network 500. Note that, in “selfie generation NN”, the diffusion model is conditioned on two parameters: (1) the input image, (2) the Lambertian rendering. In FIG. 7A, the image encoder's output is added to the diffusion model's Unet's encoder. In FIG. 7B, the image encoder's output is added to the diffusion model's Unet's decoder. In FIG. 7C, the Lambertian rendering is added to the diffusion model's Unet's decoder.

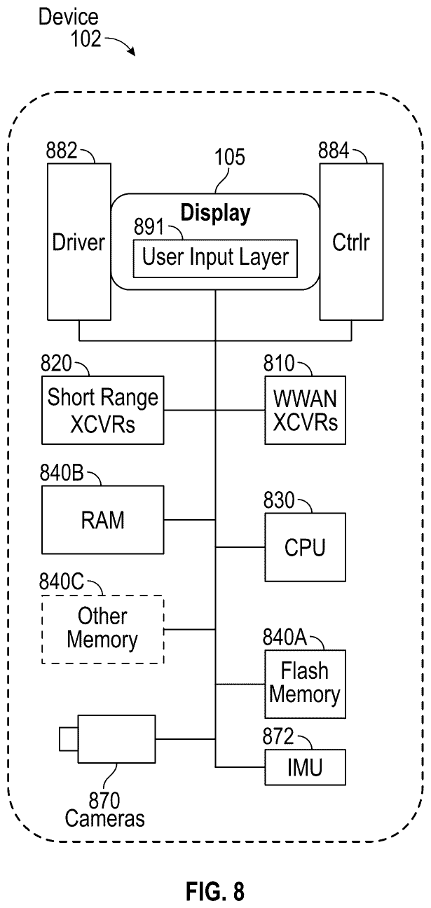

FIG. 8 is a high-level functional block diagram of an example mobile device 102 for use in implementing a personalized aesthetically enhanced model. Mobile device 102 includes a flash memory 840A that stores programming or code to be executed by a CPU 830 to perform all or a subset of the functions described herein. Flash memory 840A may further include multiple images or video, which are generated via the cameras 870 or received from another device via transceivers 810/820.

The mobile device 102 includes one or more cameras 870. The cameras 870 may include a user-facing camera on one side of the mobile device (which may be used to capture a selfie) and an away-facing camera system on the opposite side of the mobile device 102.

As shown, the mobile device 102 includes an image display 105. An image display driver 882 and controller 884, under control of CPU 830, control the display of images on the image display 105. In the example of FIG. 8, the image display 105 includes a user input layer 891 (e.g., a touchscreen) that is layered on top of or otherwise integrated into the screen used by the image display 105. The image display driver 882 and controller 884 are coupled to the CPU 830 in order to drive the display 105.

The mobile device 102 may be a touchscreen-type mobile device. Examples of touchscreen-type mobile devices that may be used include (but are not limited to) a smart phone, a personal digital assistant (PDA), a tablet computer, a laptop computer, or other portable device. However, the structure and operation of the touchscreen-type devices is provided by way of example; the subject technology as described herein is not intended to be limited thereto. For purposes of this discussion, FIG. 1B therefore provides a block diagram illustration of the example mobile device 102 with a user interface that includes a touchscreen input layer 891 for receiving input (by touch, multi-touch, or gesture, and the like, by hand, stylus or other tool) and an image display 105 for displaying content.

As shown in FIG. 8, the mobile device 102 includes at least one digital transceiver (XCVR) 810, shown as WWAN XCVRs, for digital wireless communications via a wide-area wireless mobile communication network. The mobile device 102 also includes additional digital or analog transceivers, such as short-range transceivers (XCVRs) 820 for short-range network communication, such as via NFC, VLC, DECT, ZigBee, Bluetooth™, or WiFi. For example, short range XCVRs 820 may take the form of any available two-way wireless local area network (WLAN) transceiver of a type that is compatible with one or more standard protocols of communication implemented in wireless local area networks, such as one of the WiFi standards under IEEE 802.11.

The mobile device 102 includes one or more motion/orientation-sensing components referred to as an orientation sensor (IMU) 872. The motion-sensing components may be micro-electro-mechanical systems (MEMS) with microscopic moving parts incorporated into a microchip. The orientation sensor 872 in some example configurations includes an accelerometer, a gyroscope, and a magnetometer. The accelerometer senses the linear acceleration of the device 102 (including the acceleration due to gravity) relative to three orthogonal axes (x, y, z). The gyroscope senses the angular velocity of the device 102 about three axes of rotation (pitch, roll, yaw). Together, the accelerometer and gyroscope can provide position, orientation, and motion data about the device relative to six axes (x, y, z, pitch, roll, yaw). The magnetometer, if present, senses the heading of the device 102 relative to magnetic north. The position of the device 102 may be determined using one or more of image information, location sensors, such as a GPS unit, one or more transceivers to generate relative position coordinates, altitude sensors or barometers, or other orientation sensors.

The orientation sensor 872 may include or cooperate with a digital motion processor or programming that gathers the raw data from the components and computes a number of useful values about the position, orientation, and motion of the device 102. For example, the acceleration data gathered from the accelerometer can be integrated to obtain the velocity relative to each axis (x, y, z); and integrated again to obtain the position of the device 102 (in linear coordinates, x, y, and z). The angular velocity data from the gyroscope can be integrated to obtain the position of the device 102 (in spherical coordinates). The programming for computing these useful values may be stored in memory 840 and executed by the CPU 830.

To generate location coordinates for positioning of the mobile device 102, the mobile device 102 can include a global positioning system (GPS) receiver. Alternatively, or additionally, the mobile device 102 can utilize either or both the short range XCVRs 820 and WWAN XCVRs 810 for generating location coordinates for positioning. For example, cellular network, WiFi, or Bluetooth™ based positioning systems can generate very accurate location coordinates, particularly when used in combination. Such location coordinates can be transmitted to the eyewear device over one or more network connections via XCVRs 810, 820. Alternatively, or additionally, the mobile device 102 may use images captured by the cameras 870 and computer vision algorithms (such as simultaneous location and mapping (SLAM) algorithms) to extract three-dimensional data about the physical world from the data captured in digital images or video.

The transceivers 810, 820 (i.e., the network communication interface) conform to one or more of the various digital wireless communication standards utilized by modern mobile networks. Examples of WWAN transceivers 810 include (but are not limited to) transceivers configured to operate in accordance with Code Division Multiple Access (CDMA) and 3rd Generation Partnership Project (3GPP) network technologies including, for example and without limitation, 3GPP type 2 (or 3GPP2) and LTE, at times referred to as “4G,” and 5G. For example, the transceivers 810, 820 provide two-way wireless communication of information including digitized audio signals, still image and video signals, web page information for display as well as web-related inputs, and various types of mobile message communications to/from the mobile device 102.

The mobile device 102 further includes a microprocessor that functions as a central processing unit (CPU); shown as CPU 830 in FIG. 8. A processor is a circuit having elements structured and arranged to perform one or more processing functions, typically various data processing functions. Although discrete logic components could be used, the examples utilize components forming a programmable CPU. A microprocessor, for example, includes one or more integrated circuit (IC) chips incorporating the electronic elements to perform the functions of the CPU. The CPU 830, for example, may be based on any known or available microprocessor architecture, such as a Reduced Instruction Set Computing (RISC) using an ARM architecture, as commonly used today in mobile devices and other portable electronic devices. Of course, other arrangements of processor circuitry may be used to form the CPU 830 or processor hardware in smartphone, laptop computer, and tablet.

The CPU 830 serves as a programmable host controller for the mobile device 102 by configuring the mobile device 102 to perform various operations, for example, in accordance with instructions or programming executable by CPU 830. Example operations include various general operations of the mobile device, as well as operations related to the programming for applications on the mobile device 102.

The mobile device 102 includes a memory or storage system for storing programming and data. The illustrated memory system includes a flash memory 840A, a random-access memory (RAM) 840B, and other memory components 840C. The RAM 840B serves as short-term storage for instructions and data being handled by the CPU 830, e.g., as a working data processing memory. The flash memory 840A typically provides longer-term storage.

In the example of mobile device 102, the flash memory 840A is used to store programming or instructions for execution by the CPU 830. Depending on the type of device, the mobile device 102 stores and runs a mobile operating system through which specific applications are executed. Examples of mobile operating systems include Google Android, Apple IOS (for iPhone or iPad devices), Windows Mobile, Amazon Fire OS, RIM BlackBerry OS, or the like.

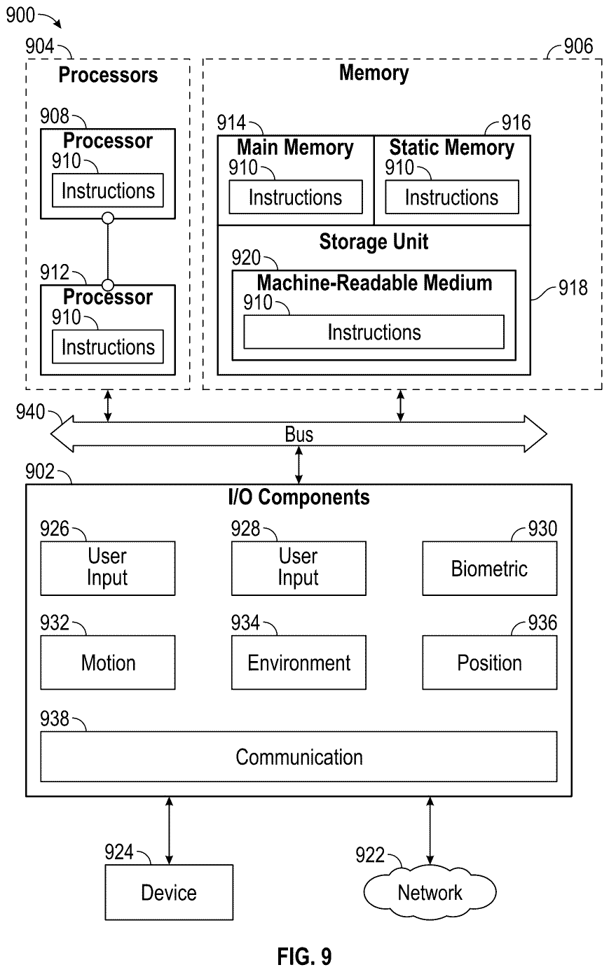

FIG. 9 is a diagrammatic representation of the machine 900 within which instructions 910 (e.g., software, a program, an application, an applet, an app, or other executable code) for causing the machine 900 to perform one or more of the methodologies discussed herein may be executed. For example, the instructions 910 may cause the machine 900 (which may be integrated into the mobile device 102) to execute one or more of the methods described herein. The instructions 910 transform the general, non-programmed machine 900 into a particular machine 900 programmed to carry out the described and illustrated functions in the manner described. The machine 900 may operate as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may include, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 910, sequentially or otherwise, that specify actions to be taken by the machine 900. Further, while only a single machine 900 is illustrated, the term “machine” shall also be taken to include a collection of machines that individually or jointly execute the instructions 910 to perform one or more of the methodologies discussed herein. In some examples, the machine 900 may also include both client and server systems, with certain operations of a particular method or algorithm being performed on the server-side and with certain operations of the particular method or algorithm being performed on the client-side.

The machine 900 may include processors 904, memory 906, and input/output I/O components 902, which may be configured to communicate with each other via a bus 940. In an example, the processors 904 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 908 and a processor 912 that execute the instructions 910. The term “processor” is intended to include multi-core processors that may include two or more independent processors (sometimes referred to as “cores”) that may execute instructions contemporaneously. Although FIG. 9 shows multiple processors 904, the machine 900 may include a single processor with a single core, a single processor with multiple cores (e.g., a multi-core processor), multiple processors with a single core, multiple processors with multiples cores, or any combination thereof.

The memory 906 includes a main memory 914, a static memory 916, and a storage unit 918, both accessible to the processors 904 via the bus 940. The main memory 906, the static memory 916, and storage unit 918 store the instructions 910 for one or more of the methodologies or functions described herein. The instructions 910 may also reside, completely or partially, within the main memory 914, within the static memory 916, within machine-readable medium 920 within the storage unit 918, within at least one of the processors 904 (e.g., within the Processor's cache memory), or any suitable combination thereof, during execution thereof by the machine 900.

The I/O components 902 may include a wide variety of components to receive input, provide output, produce output, transmit information, exchange information, capture measurements, and so on. The specific I/O components 902 that are included in a particular machine will depend on the type of machine. For example, portable machines such as mobile phones may include a touch input device or other such input mechanisms, while a headless server machine will likely not include such a touch input device. It will be appreciated that the I/O components 902 may include many other components that are not shown in FIG. 9. In various examples, the I/O components 902 may include user output components 926 and user input components 928. The user output components 926 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 928 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 902 may include biometric components 930, motion components 932, environmental components 934, or position components 936, among a wide array of other components. For example, the biometric components 930 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 932 include acceleration sensor components (e.g., accelerometer), gravitation sensor components, rotation sensor components (e.g., gyroscope).

The environmental components 934 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

The position components 936 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 902 further include communication components 938 operable to couple the machine 900 to a network 922 or devices 924 via respective coupling or connections. For example, the communication components 938 may include a network interface Component or another suitable device to interface with the network 922. In further examples, the communication components 938 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 924 may be another machine or any of a wide variety of peripheral devices (e.g., a peripheral device coupled via a USB).

Moreover, the communication components 938 may detect identifiers or include components operable to detect identifiers. For example, the communication components 938 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 938, such as location via Internet Protocol (IP) geolocation, location via Wi-Fi® signal triangulation, location via detecting an NFC beacon signal that may indicate a particular location, and so forth.

The various memories (e.g., main memory 914, static memory 916, and memory of the processors 904) and storage unit 918 may store one or more sets of instructions and data structures (e.g., software) embodying or used by one or more of the methodologies or functions described herein. These instructions (e.g., the instructions 910), when executed by processors 904, cause various operations to implement the disclosed examples.

The instructions 910 may be transmitted or received over the network 922, using a transmission medium, via a network interface device (e.g., a network interface component included in the communication components 938) and using any one of several well-known transfer protocols (e.g., hypertext transfer protocol (HTTP)). Similarly, the instructions 910 may be transmitted or received using a transmission medium via a coupling (e.g., a peer-to-peer coupling) to the devices 924.

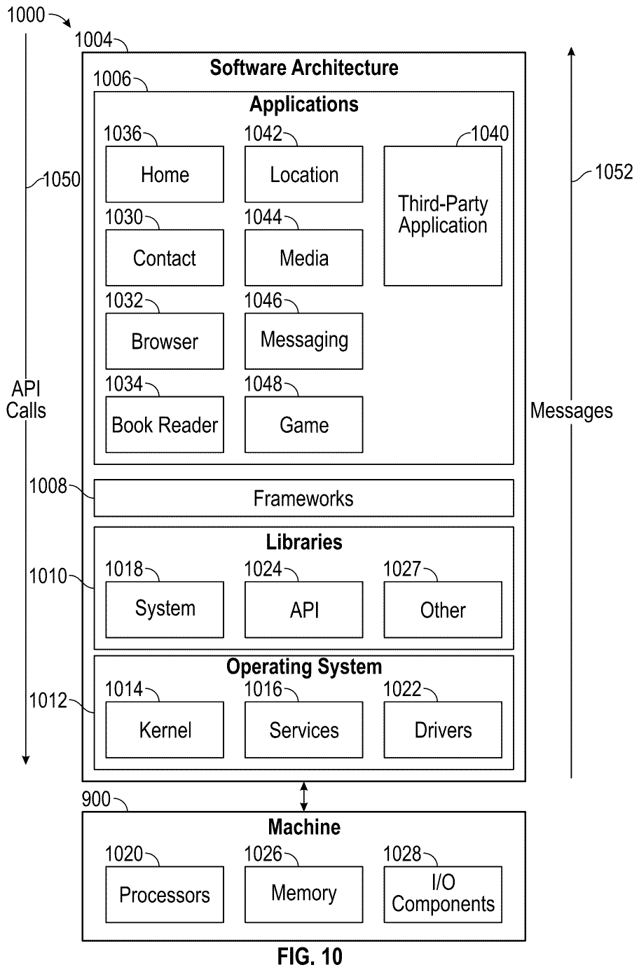

FIG. 10 is a block diagram 1000 illustrating a software architecture 1004, which can be installed on one or more of the devices described herein. The software architecture 1004 is supported by hardware such as a machine 900 (see FIG. 9) that includes processors 1020, memory 1026, and I/O components 1028. In this example, the software architecture 1004 can be conceptualized as a stack of layers, where each layer provides a particular functionality. The software architecture 1004 includes layers such as an operating system 1012, libraries 1010, frameworks 1008, and applications 1006. Operationally, the applications 1006 invoke API calls 1050 through the software stack and receive messages 1052 in response to the API calls 1050.

The operating system 1012 manages hardware resources and provides common services. The operating system 1012 includes, for example, a kernel 1014, services 1016, and drivers 1022. The kernel 1014 acts as an abstraction layer between the hardware and the other software layers. For example, the kernel 1014 provides memory management, processor management (e.g., scheduling), component management, networking, and security settings, among other functionality. The services 1016 can provide other common services for the other software layers. The drivers 1022 are responsible for controlling or interfacing with the underlying hardware. For instance, the drivers 1022 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1010 provide a common low-level infrastructure used by the applications 1006. The libraries 1010 can include system libraries 1018 (e.g., C standard library) that provide functions such as memory allocation functions, string manipulation functions, mathematic functions, and the like. In addition, the libraries 1010 can include API libraries 1024 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1010 can also include a wide variety of other libraries 1027 to provide many other APIs to the applications 1006.

The frameworks 1008 provide a common high-level infrastructure that is used by the applications 1006. For example, the frameworks 1008 provide various graphical user interface (GUI) functions, high-level resource management, and high-level location services. The frameworks 1008 can provide a broad spectrum of other APIs that can be used by the applications 1006, some of which may be specific to a particular operating system or platform.

In an example, the applications 1006 may include a home application 1036, a contacts application 1030, a browser application 1032, a book reader application 1034, a location application 1042, a media application 1044, a messaging application 1046, a game application 1048, and a broad assortment of other applications such as a third-party application 1040. The applications 1006 are programs that execute functions defined in the programs. Various programming languages can be employed to generate one or more of the applications 1006, structured in a variety of manners, such as object-oriented programming languages (e.g., Objective-C, Java, or C++) or procedural programming languages (e.g., C or assembly language). In a specific example, the third-party application 1040 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1040 can invoke the API calls 1050 provided by the operating system 1012 to facilitate functionality described herein.

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component includes a general-purpose processor configured by software to become a special-purpose processor, the general-purpose processor may be configured as respectively different special-purpose processors (e.g., including different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method for aesthetically enhancing an input selfie image, the method comprising:
receiving manipulation guidance;
applying a first neural network to the input selfie image to obtain visual manipulation guidance in the form of a new rendered image, the first neural network based on public facial preferences and personalized preferences of a user and responsive to the manipulation guidance;
concatenating the new rendered image with noise;
applying a second neural network to the concatenated rendered image with noise to generate at least one output image including the user, the second neural network based on select images of the user; and
presenting one or more of the at least one output image on a display.

2. The method of claim 1, wherein the manipulation guidance includes a manipulation magnitude value and a manipulation instruction and wherein the method further comprises: presenting a graphical user interface on the display, the graphical user interface comprising a slider configured to receive the manipulation magnitude value and a text box configured to receive the manipulation instruction.

3. The method of claim 1, wherein the at least one output image includes a first output image and a second output image and wherein the method further comprises:
presenting a graphical user interface on the display, the graphical user interface responsive to a finger gesture on the display; and
selectively displaying the first output image or the second output image on the display responsive to the finger gesture on the graphical user interface.

4. The method of claim 1, wherein the manipulation guidance includes a manipulation magnitude value and a manipulation instruction and wherein the method further comprises:
estimating parameters of the new rendered image, the parameters including surface normals, lighting, and albedo;
extracting a weight map and a feature map from the input selfie image; and
warping the estimated parameters including the weight map and the feature map to be spatially aligned with the new rendered image;
wherein the first neural network is responsive to the manipulation magnitude value and the manipulation instruction.

5. The method of claim 1, wherein the manipulation guidance includes a manipulation magnitude value and a manipulation instruction and wherein training the first neural network comprises:
encoding a public face attractiveness dataset using a variational autoencoder (VAE) encoder and convolutional net head and a Bayesian ridge regressor to generate an attractiveness score;
identifying photos on a mobile device that are at least one of liked, saved, or disliked;
encoding the identified photos with the VAE to fine-tune the convolutional net head and the Bayesian ridge regressor to update the attractiveness score;
encoding the input selfie image with the VAE encoder;
processing manipulation text instructions with a contrastive language-image pre-training (CLIP) encoder;
generating a plurality of rendered images with a VAE decoder and corresponding attractiveness scores; and
updating weights of the first neural network by maximizing the attractiveness score following the manipulation magnitude and the manipulation text instructions.

6. The method of claim 1, wherein training the second neural network comprises:
training a Lambertian rendering as an input, unconditional, generalized face diffusion model;
training an image encoder of a generalized, conditional diffusion model focused on face restoration;
fine-tuning the image encoder using a video of the face of the user;
obtaining images of the face of the user selected by the user; and
personalizing the conditional diffusion model using the obtained images.

7. The method of claim 1, wherein the second neural network is a diffusion model conditioned on the input selfie image and the rendered image, the diffusion model includes an image encoder and a U-net convolutional neural network encoder and decoder, and wherein applying the second neural network comprises:
adding an output of the image encoder to at least one of the U-net convolutional neural network encoder or decoder.

8. A mobile device for aesthetically enhancing an input selfie image depicting a user, the mobile device comprising:
a camera configured to capture the input selfie image;
a display;
a user interface configured to receive manipulation guidance;
a memory including a first neural network, a second neural network, and instructions, the first neural network based on public face preferences and personalized preferences of the user and the second neural network based on select images of the user;
a processor coupled to the camera, the display, and the user interface, and the memory, the processor configured to execute the instructions, the instructions, when executed by the processor configured the mobile device to:
receive, via the user interface, manipulation guidance;
apply the first neural network to the input selfie image to obtain visual manipulation guidance in the form of a new rendered image, the first neural network responsive to the manipulation guidance;
concatenate the new rendered image with noise;
apply the second neural network to the concatenated rendered image with noise to generate at least one output image including the user; and
present one or more of the at least one output image on the display.

9. The mobile device of claim 8, wherein the manipulation guidance includes a manipulation magnitude value and a manipulation instruction and wherein the instructions, when executed by the processor, further configure the mobile device to:
present a graphical user interface on the display, the graphical user interface comprising a slider configured to receive the manipulation magnitude value and a text box configured to receive the manipulation instruction.

10. The mobile device of claim 8, wherein the at least one output image includes a first output image and a second output image and wherein the instructions, when executed by the processor, further configure the mobile device to:
present a graphical user interface on the display, the graphical user interface responsive to a finger gesture on the display; and
selectively display the first output image or the second output image on the display responsive to the finger gesture on the graphical user interface.

11. The mobile device of claim 8, wherein the manipulation guidance includes a manipulation magnitude value and a manipulation instruction and wherein the instructions, when executed by the processor, further configure the mobile device to:
estimate parameters of the new rendered image, the parameters including surface normals, lighting, and albedo;
extract a weight map and a feature map from the input selfie image; and
warp the estimated parameters including the weight map and the feature map to be spatially aligned with the new rendered image;
wherein the first neural network is responsive to the manipulation magnitude value and the manipulation instruction.

12. The mobile device of claim 8, wherein the manipulation guidance includes a manipulation magnitude value and a manipulation instruction and wherein to train the first neural network the instructions, when executed by the processor, further configure the mobile device to:
encode a public face attractiveness dataset using a variational autoencoder (VAE) encoder and convolutional net head and a Bayesian ridge regressor to generate an attractiveness score;
identify photos on the mobile device that are at least one of liked, saved, or disliked;
encode the identified photos with the VAE to fine-tune the convolutional net head and the Bayesian ridge regressor to update the attractiveness score;
encode the input selfie image with the VAE encoder;
process manipulation text instructions with a contrastive language-image pre-training (CLIP) encoder;
generate a plurality of rendered images with a VAE decoder and corresponding attractiveness scores; and
update weights of the first neural network by maximizing the attractiveness score following the manipulation magnitude and the manipulation text instructions.

13. The mobile device of claim 8, wherein to train the second neural network the instructions, when executed by the processor, further configure the mobile device to:
train a Lambertian rendering as an input, unconditional, generalized face diffusion model;
train an image encoder of a generalized, conditional diffusion model focused on face restoration;
fine-tune the image encoder using a video of the face of the user;
obtain images of the face of the user selected by the user; and
personalize the conditional diffusion model using the obtained images.

14. The mobile device of claim 8, wherein the second neural network is a diffusion model conditioned on the input selfie image and the rendered image, the diffusion model includes an image encoder and a U-net convolutional neural network encoder and decoder, and the second neural network adds an output of the image encoder to at least one of the U-net convolutional neural network encoder or decoder.

15. A non-transitory computer-readable medium including instructions for aesthetically enhancing an input selfie image depicting a user with a mobile device, the instructions, when executed by a processor of the mobile device, configure the mobile device to:
receive manipulation guidance;
apply a first neural network to the input selfie image to obtain visual manipulation guidance in the form of a new rendered image, the first neural network based on public face preferences and personalized preferences of the user and responsive to the manipulation guidance;
concatenate the new rendered image with noise;
apply a second neural network to the concatenated rendered image with noise to generate at least one output image including the user, the second neural network based on select images of the user; and
present one or more of the at least one output image on a display of the mobile device.

16. The non-transitory computer-readable medium of claim 15, wherein the manipulation guidance includes a manipulation magnitude value and a manipulation instruction and wherein the instructions, when executed by the processor of the mobile device, further configure the mobile device to:
present a graphical user interface on the display, the graphical user interface comprising a slider configured to receive the manipulation magnitude value and a text box configured to receive the manipulation instructions.

17. The non-transitory computer-readable medium of claim 15, wherein the at least one output image includes a first output image and a second output image and wherein the instructions, when executed by the processor of the mobile device, further configure the mobile device to:
present a graphical user interface on the display, the graphical user interface responsive to a finger gesture on the display; and
selectively display the first output image or the second output image on the display responsive to the finger gesture on the graphical user interface.

18. The non-transitory computer-readable medium of claim 15, wherein the manipulation guidance includes a manipulation magnitude value and a manipulation instruction and wherein the instructions, when executed by the processor of the mobile device, further configure the mobile device to:
estimate parameters of the new rendered image, the parameters including surface normals, lighting, and albedo;
extract a weight map and a feature map from the input selfie image; and
warp the estimated parameters including the weight map and the feature map to be spatially aligned with the new rendered image;
wherein the first neural network is responsive to the manipulation magnitude value and the manipulation instruction.

19. The non-transitory computer-readable medium of claim 15, wherein the manipulation guidance includes a manipulation magnitude value and a manipulation instruction and wherein to train the first neural network the instructions, when executed by the processor of the mobile device, further configure the mobile device to:
encode a public dataset using a first variational autoencoder (VAE) encoder and convolutional net head and a Bayesian ridge regressor to generate an attractiveness score;
identify photos on the mobile device that are at least one of liked, saved, or disliked;
encode the identified photos with the VAE to fine-tune the convolutional net head and the Bayesian ridge regressor to update the attractiveness score;
encode the input selfie image with the VAE encoder;
process manipulation text instructions with a contrastive language-image pre-training (CLIP) encoder;
generate a plurality of rendered images with a VAE decoder and corresponding attractiveness scores; and
update weights of the first neural network by maximizing the attractiveness score following the manipulation magnitude and the manipulation text instructions.

20. The non-transitory computer-readable medium of claim 19, wherein to train the second neural network the instructions, when executed by the processor of the mobile device, further configure the mobile device to:
train a Lambertian rendering as an input, unconditional, generalized face diffusion model;
train an image encoder of a generalized, conditional diffusion model focused on face restoration;
fine-tune the image encoder using a video of the face of the user;
obtain images of the face of the user selected by the user; and
personalize the conditional diffusion model using the obtained images.
